(19) United States
(12) Patent Application Publication
(10) Pub. No.: US 2003/0100421 A1
(43) Pub. Date: May 29, 2003

(54) Box for transportation

(76) Inventor: Sunju Lee, Gyeonggi-do (KR)

Correspondence Address: SHERIDAN ROSS PC, 1560 BROADWAY, SUITE 1200, DENVER, CO, 80202

(21) Appl. No.: 10/035,917

(22) Filed: Dec. 28, 2001

(30) Foreign Application Priority Data
Dec. 30, 2000 (KR) 20-2000-37259
Dec. 30, 2000 (KR) 20-2000-37258
May 4, 2001 (KR) 20-2001-13081

(51) Int. Cl. B31B 9/00

(52) U.S. Cl. 493/52

(57) ABSTRACT

A box for transportation that has a bottom, which is composed of just one facet of paper, can be assembled without any particular fixing method in order to prevent from missing the contents inside of the box, and after the two facets of one side are overlapped each other, the perforations are formed around the handle hole, then an assistant sheet that a combination apparatus and so on are formed is combined, and the said problems of the prior art are solved.

### BACKGROUND OF THE INVENTION

1. Field of the Invention

The present invention relates to a box for transportation made of paper or synthetic resins, which is used for transportation, especially when a box is carried, the box that has a bottom, which is composed of just one facet of paper, can be assembled without any particular fixing method in order to prevent from missing the contents inside of the box.

In the prior art, for forming the box that has a bottom, which is composed of just one plane facet of paper, as shown in FIGS. 17 to 19, the side facets (100, 100a, 100b) should be folded and fixed by only staples (300) or glue, so the box is formed, and the handle (400) on the sides is formed by cutting.

Therefore, because only staples (300) or glue assembles the box, this kind of adding another composition makes inconvenient to produce and to recycle the boxes as well as inconvenience to dissemble the boxes makes that the volume of the box is too large during transportation, which comes to the high transportation cost, also the handle (400) that is formed by cutting on the sides can be easily torn by the contents.

2. Discussion of Related Art

Thus, in order to solve the above-mentioned problem for the present invention, after the two facets of one side are overlapped each other, the perforations are formed around the handle hole. Then an assistant sheet that a combination apparatus and so on are formed is combined, and the said problems of the prior art are solved.

### BRIEF DESCRIPTION OF THE ATTACHED DRAWINGS

FIG. 1 is a perspective view showing the embodiment of the present invention;

FIG. 2 is an assembling view showing that a box of FIG. 1 is assembled;

FIG. 3 is a perspective view showing that an assistant sheet is combined with a box made of synthetic resins as shown in FIG. 1;

FIG. 4 is a perspective view showing that a corner fixing apparatus is installed when the assistant sheet is combined;

FIG. 5 is a perspective view showing another embodiment of the present invention;

FIG. 6 is a perspective view showing that a box of FIG. 5 is assembled;

FIG. 7 is a perspective view showing that another assistant sheet is combined with a box made of synthetic resins as shown in FIG. 5;

FIG. 8 is a perspective view showing that the assistant sheet is dissembled;

FIG. 9 is a perspective showing that the assistant sheet is formed as one due to the folding part;

FIG. 10 is a perspective view showing that a combination screw and combination nut combines the assistant sheet;

FIG. 11 is a perspective view showing that the assistant sheet is folded;

FIG. 11A is a perspective view showing that holes are formed on the combination hole;

FIG. 12 is a perspective view showing that the assistant sheet is formed as one due to the soft material;

FIG. 13 is a perspective view showing that the folding part is dissembled and combined;

FIG. 14 is a perspective view showing that the folding part is formed on just one cover sheet;

FIG. 15 is a perspective view showing that a stopper, which is formed some perforations, is formed on the assistant sheet;

FIG. 16 is a cross sectional showing that the assistant sheet is combined with an already assembled box;

FIG. 17 is a development view of the prior art;

FIG. 18 is an assembling view showing that a box of the prior art is being assembled; and

FIG. 19 is a perspective view showing that a box of the prior art has already assembled.

### DETAILED DESCRIPTION OF PREFERRED EMBODIMENT

The following is the detailed description of the most desirable embodiment of the present invention. The most desirable embodiment of this invention will be described in detail according to the attached drawings on the following and the same reference number will be used to mean the same drawing elements regardless of different drawings.

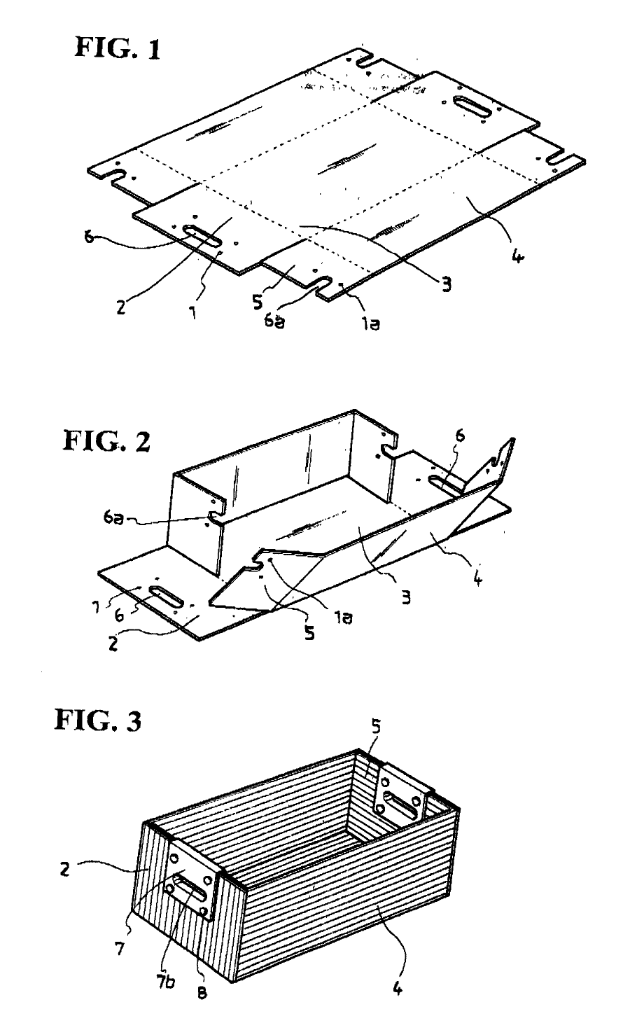

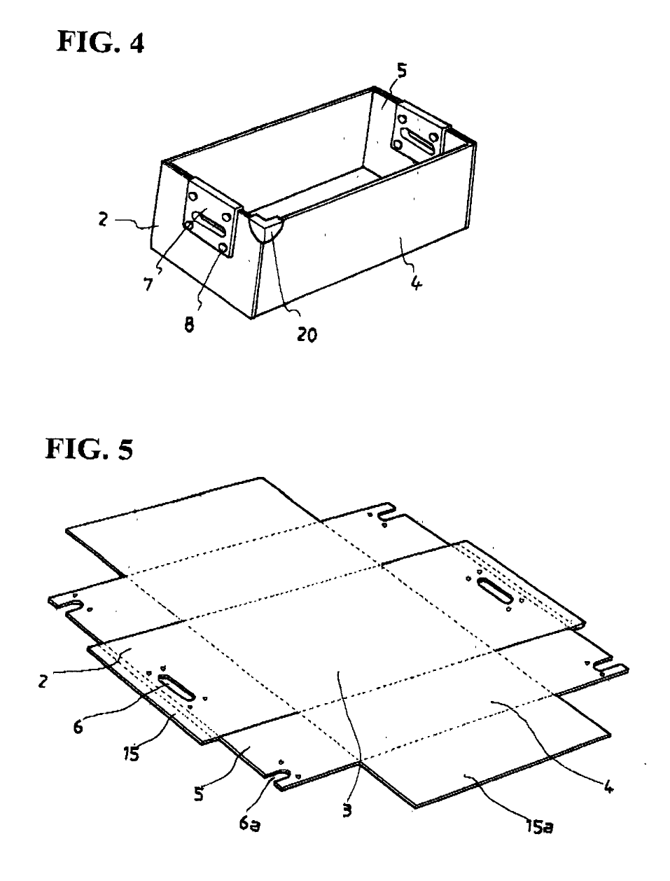

As shown in FIGS. 1 to 3, the present invention is composed as a rectangular parallelepiped, of which a bottom (3), which is composed of just one facet of paper and the first side facet (2), the second side facet (4) that are extended to forward and to side from the said bottom (3), and the third side facet (5), which is extended from side to side and folded and overlapped on the first side facet (2).

As described above, the handle hole (6) is perforated on the said first side facet (2) in order to use as a handle, and the third side facet (5) has each divided handle hole (6a).

In this situation, the third side facet (5) is positioned on the inside of the first side facet (2), so that each divided handle hole (6a) can be overlapped each other, after that the box is assembled by a combination protrusion (8) and a combination hole (9), which are formed on the assistant sheet (7), through the perforations (1, 1a) on the first side facet (2) and the third side facet (5), and then protrusion hoops (10, 10a) are in gear with each other for the handle hole (6).

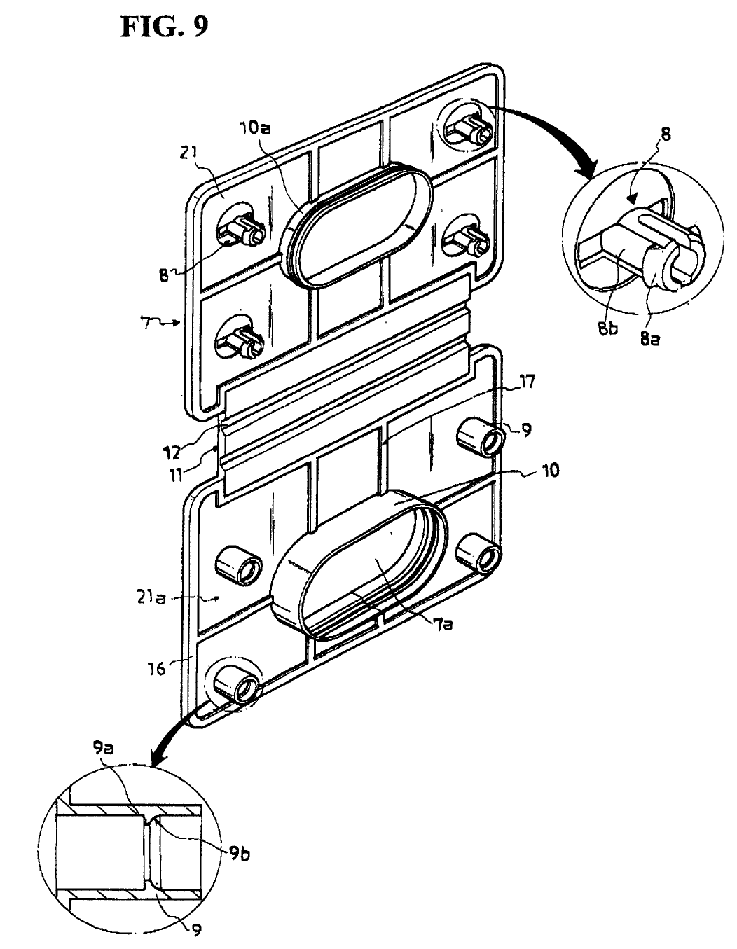

At this point, as shown in FIG. 8, the assistant sheet (7) is dissembled, or it is formed and folded as one as shown in FIG. 9, at this moment, a folding lines (12) are formed on the folding apparatus (11) in order to make convenient to be folded.

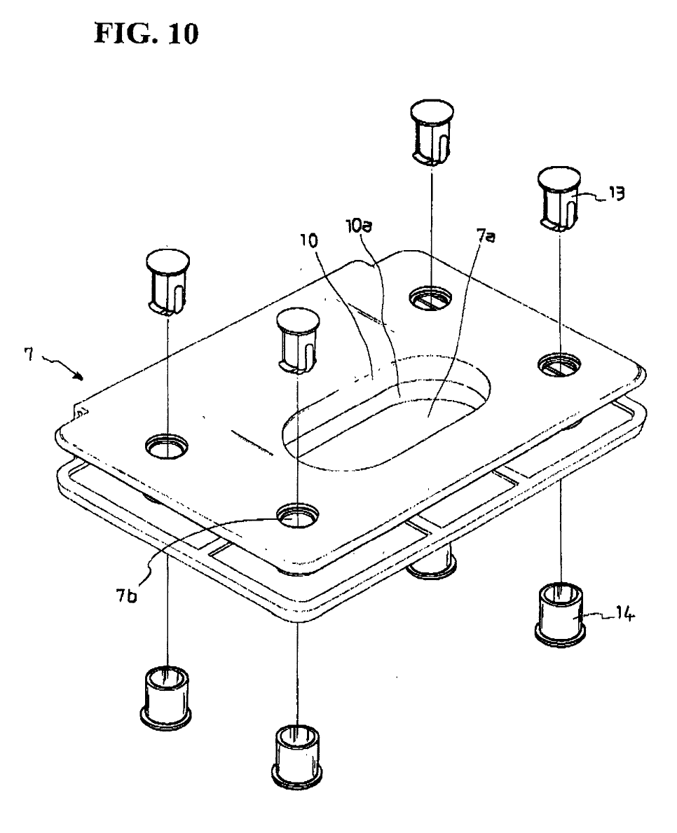

Furthermore, the assistant sheet (7) can be made of the sheet, of which a combination perforation is perforated or boards assembled with an assembling screw (13) and an assembling nut (14) as shown in FIG. 10.

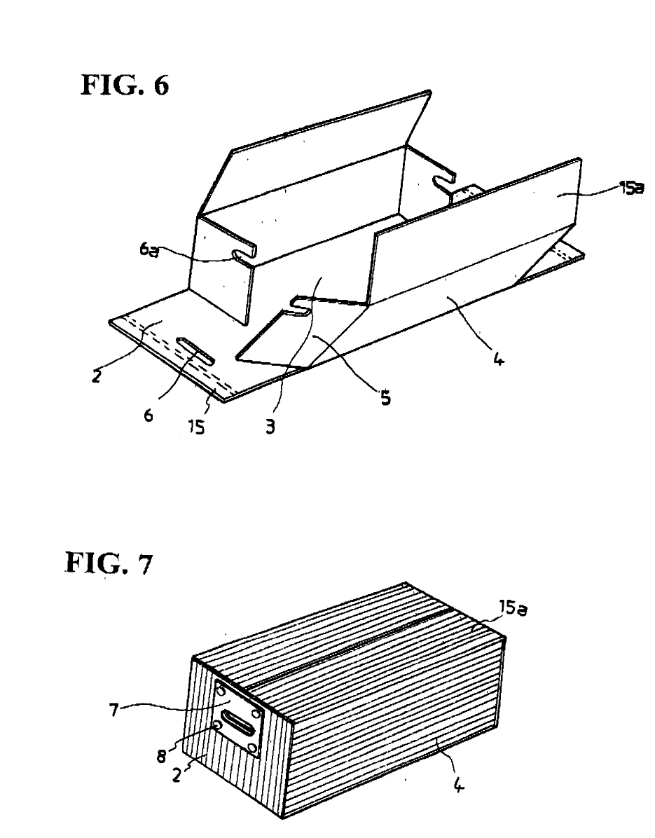

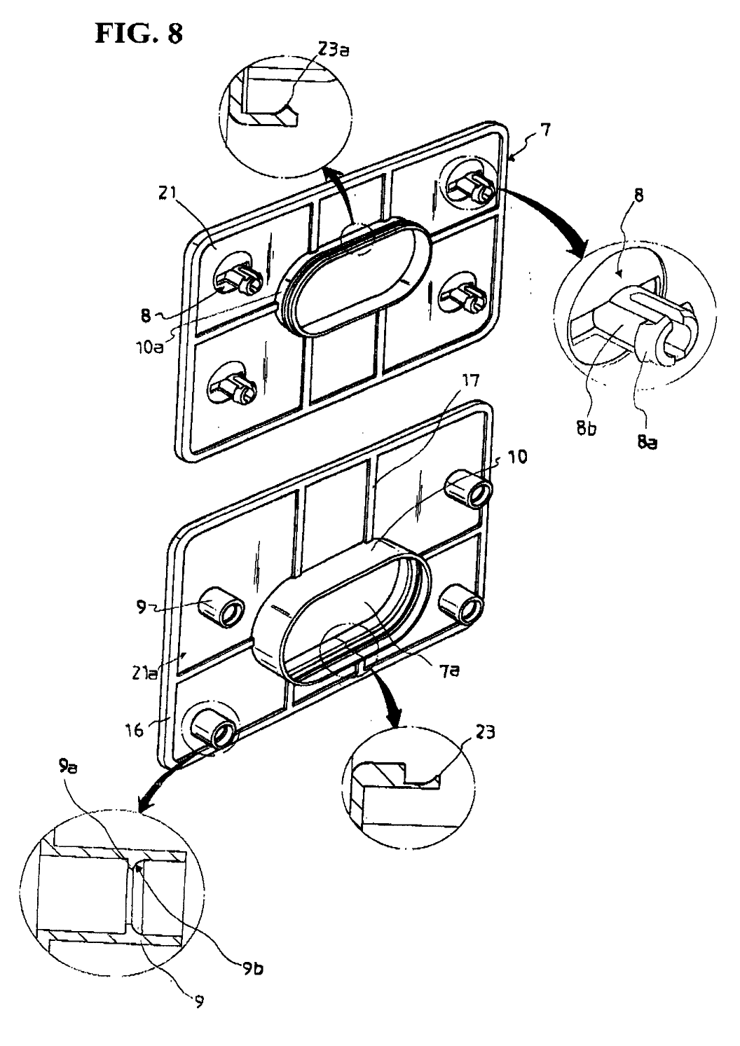

Moreover, as shown in FIGS. 5 to 7, cover sheets (15, 15a), that are extended to forward from the second side facet (4) and the first side facet (2), complete the package of the contents, and then the cover sheets (15a), which is extended from the second side facet (4), can cover more tightly by the cover sheets (15), which is extended from the first side facet (2).

The combining assistant sheets are only to be separated.

In addition, the handle hole (7a) is formed on the assistant sheet (7) in order to form a handle, and when the handle hole (7a) is formed, the protrusion hoops (10, 10a) are protruded inside and in gear with each other for the handle hole (6), so that the handle is sturdy.

The assistant sheet (7) is consisted of two cover sheets (21, 21a) and the handle hole (7a) is formed on the center of the cover sheets (21, 21a) in the same shape with the handle hole (7) of the box, and the protrusion hoops (10, 10a) are protruded toward inside of the handle hole (7a) and the said protrusion hoops (10, 10a) can be formed on the cover sheets (21, 21a).

At this point, an inward sill (22) and an outward sill (22a) are formed in the protrusion hoops (10, 10a) and geared with each other.

In addition, as shown in FIG. 8, the combination protrusion (8) and the combination hole (9), that are combined through the perforations (1), are easy to be in gear with each other, and a few of elasticity flake (8b), which is formed a hooking protrusion (8a), are formed in order not to be separated carelessly when they are be in gear with each other. A hooking hoop (9a) is formed on the combination hole (9), which is in gear with the combination protrusion (8), in order that the hooking protrusion (8a) can be hooked on. In this situation, an incline (9b) is formed on the forward part of the hooking hoop (9a), so that the combination protrusion (8) can be inserted easily.

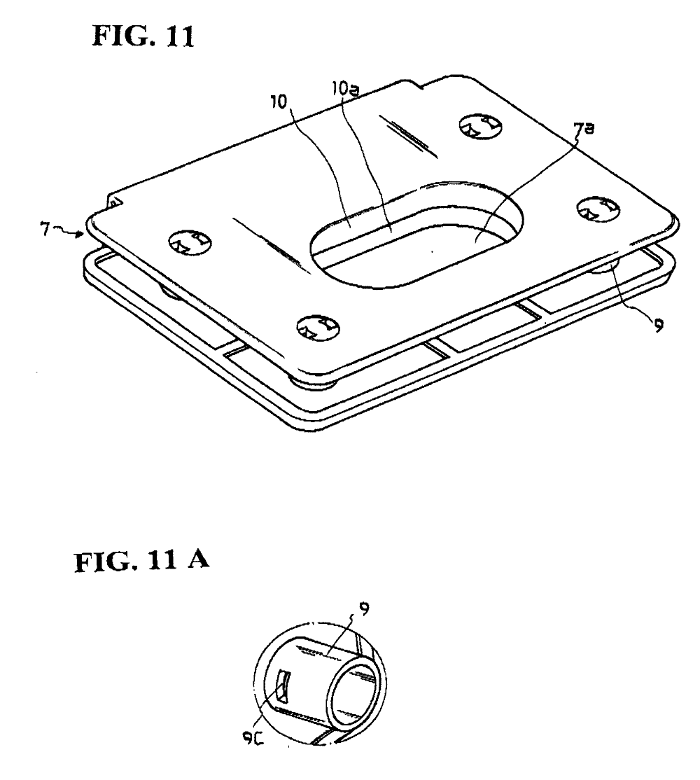

As shown in FIG. 11A, in order that the hooking protrusion (8a) of the combination protrusion (8) can be hooked on, holes (9c) are formed on the combination hole (9), as many as the number of elasticity flake (8b), which is formed the combination protrusion (8), so that the hooking protrusion (8a) of the elasticity flake (8b) is hooked on the hole (9c) in order not to be separated carelessly.

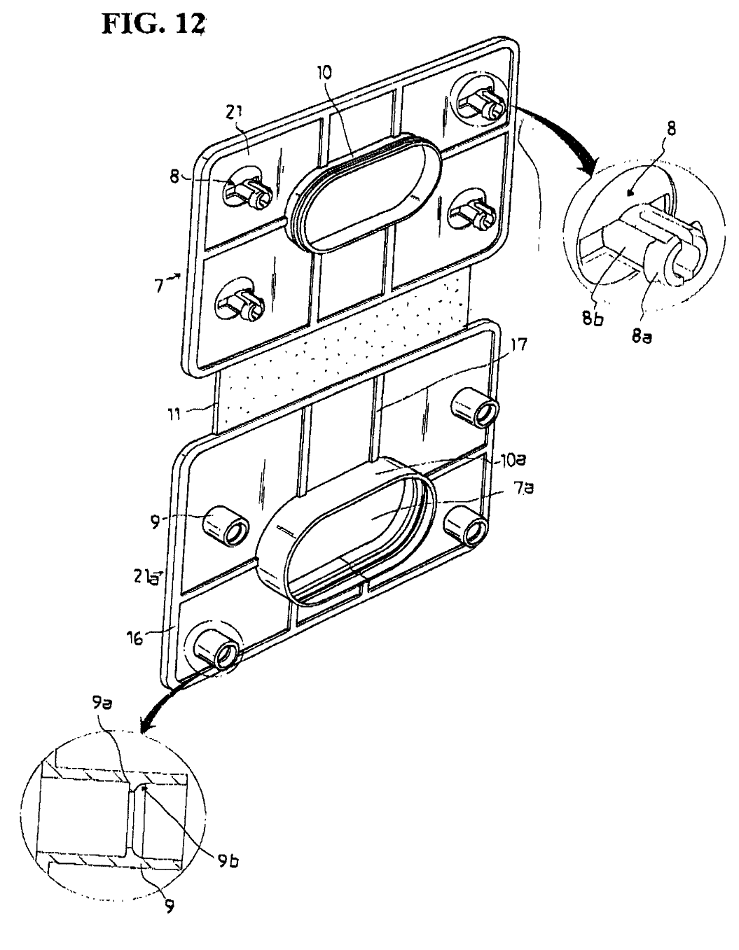

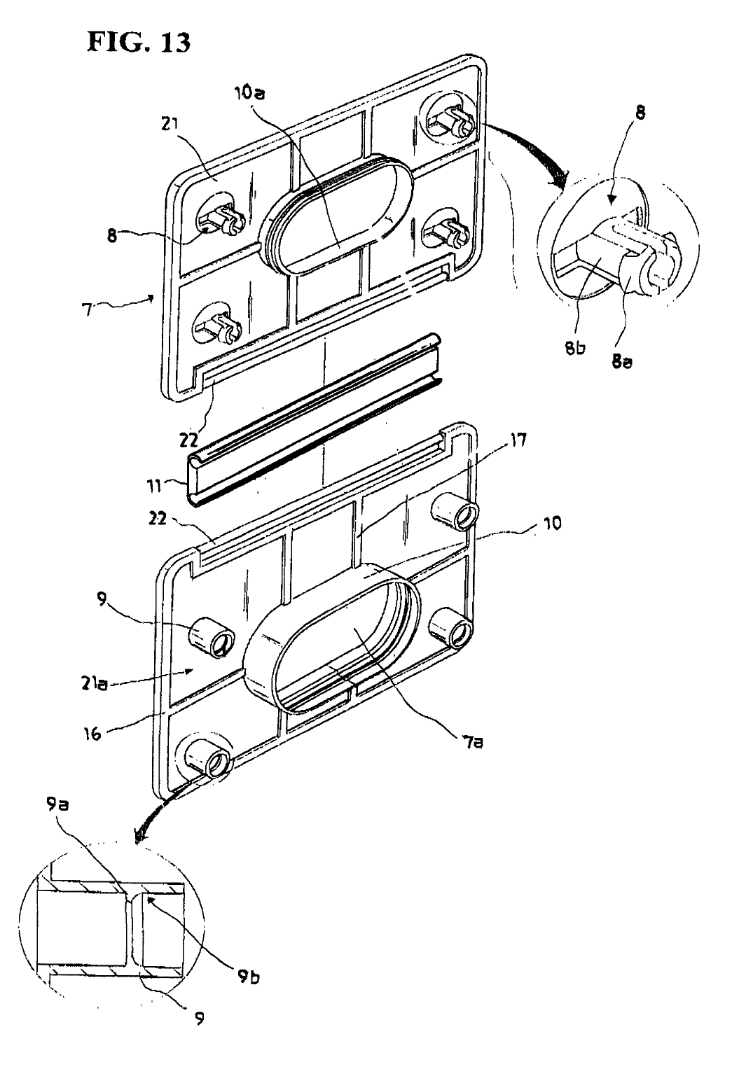

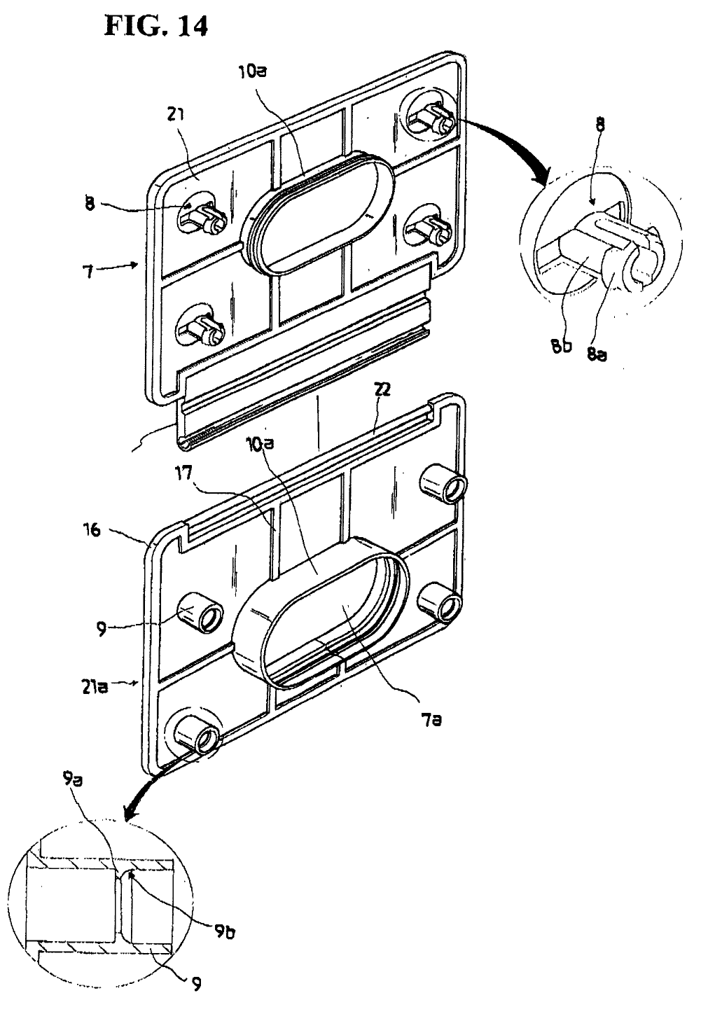

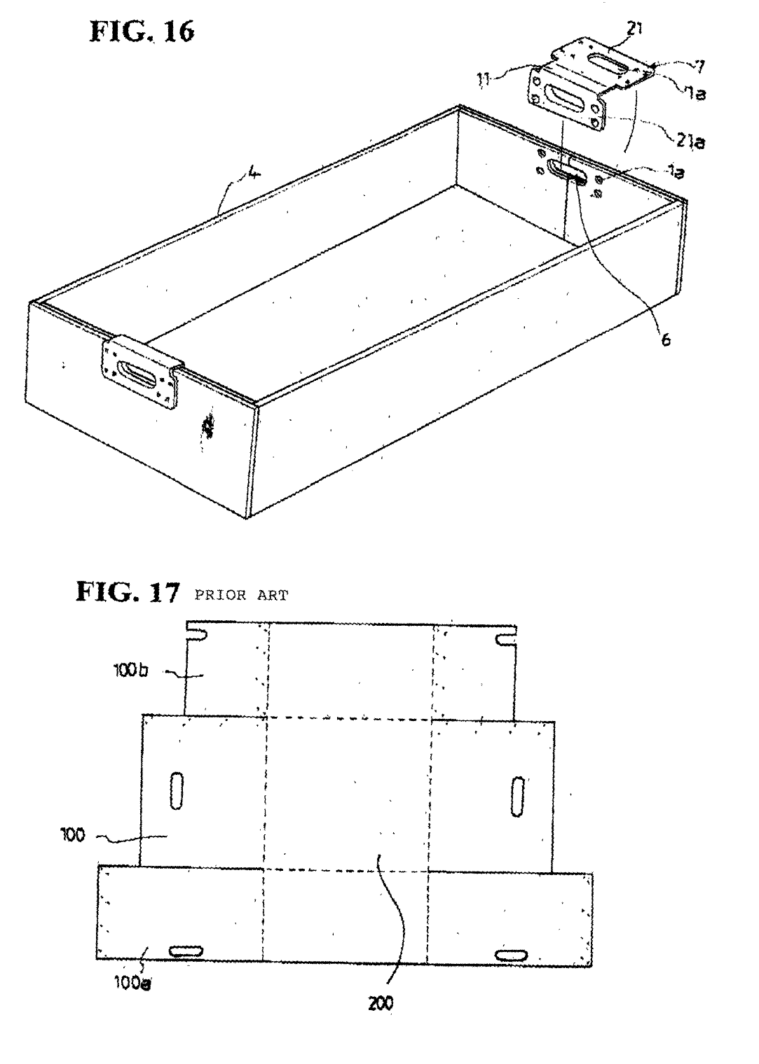

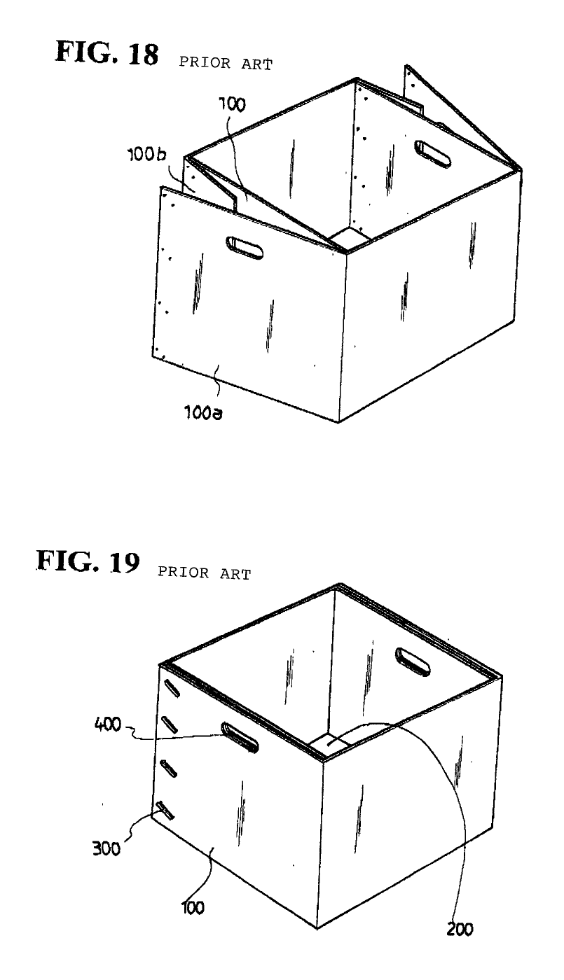

As shown in FIG. 12, when the cover sheets (21, 21a) is formed as one by the folding apparatus (11), the folding apparatus (11) is molded with a soft material by double injection, so that it is easy to be folded and designed in a various shape. As shown in FIG. 13, the folding apparatus (11) is formed as a separate composition and assembled with a hinge (22), or as shown in FIG. 14, after, the folding apparatus (11) is formed in one cover sheet (21), it is assembled with the other cover sheet (21a) by the hinge (22).

Furthermore, a strengthening border (16) and a strengthening rib (17) are formed on the cover sheets (21, 21a), so that the cover sheets (21, 21a) are not bent and this kind of composition can be used as a advertisement in a various design such as a logo and trademark.

In addition, a stopper (18) is formed on the handle hole (7a) of the cover sheets (21, 21a), so that other materials can not be inserted, and holes (19) are formed on the stopper (18) and the stopper (18) is folded or detached individually.

Moreover, corner fixing apparatus (20) is installed on each corner, after the box is assembled.

FIG. 11 shows that the assistant sheet (7) is folded.

Therefore, before a user uses the box, it can be transported and stored in a condition of being completely unfolded, so the transportation cost can be deducted, and then when the box is used. After the first side facet (2) and the third side facet (5) are folded and overlapped with each other, the handle holes (6) and the perforations (1) are adjusted one thing to another using the assistant sheet (7), so the box is completed by means of a simple assembling.

At this moment, assembling is achieved by a combination of the combination protrusion (8) and the combination hole (9), and another assembling screw (13) and an assembling nut (14) can be used also.

Thus, in condition that fixing with the assistant sheet (7) strengthens the handle, as the box is fixed only with assembling of the assistant sheet (7), the box can be recycled easily by detaching the assistant sheet (7).

What is claimed is:

1. A box for transportation, wherein comprising;
a bottom, which is composed of just one facet of paper,
the first side facet and the second side facet that are extended to forward and to side from the said bottom, and the third side facet, which is extended from side to side and folded and overlapped on the first side facet,
handle holes that are perforated on the said first side facet and the third side facet,
perforations, which are formed around the said, handle holes,
a combination protrusion and a combination hole, which are formed in order to combined through the perforations,
an assistant sheet that is formed on the handle hole, which is faced with the handle hole of the said first side facet and the third side facet.

2. A box for transportation as claimed in claim 1 wherein, cover sheets, that are extended to forward from the second side facet and the first side facet.

3. A box for transportation as claimed in claim 1 wherein, the assistant sheet is formed as one by the folding apparatus, which is formed folding lines.

4. A box for transportation as claimed in claim 1 and 3 wherein, protrusion hoops are formed toward inside of the handle hole of the assistant sheet.

5. A box for transportation as claimed in claim 1 and 3 wherein, after combination perforation are formed on the assistant sheet, an assembling screw and an assembling nut are combined with each other.

6. A box for transportation as claimed in claim 4 wherein, an inward sill and an outward sill gear protrusion hoops with each other.

7. A box for transportation as claimed in claim 4 wherein, a combination protrusion is consisted of a few of elasticity flake and a hooking hoop is formed by an incline is formed on a combination hole.

8. A box for transportation as claimed in claim 1 and 3 wherein, a strengthening border and a strengthening rib is formed on the cover sheet.

9. A box for transportation as claimed in claim 3 wherein, the folding apparatus is folded with a hinge combination.

10. A box for transportation as claimed in claim 3 wherein, the folding apparatus is molded with a soft material by double injection, so that it is easy to be folded.
